(19) United States
(12) Patent Application Publication
(10) Pub. No.: US 2002/0131450 A1
(43) Pub. Date: Sep. 19, 2002

(54) Pseudo-random pattern transmission apparatus

(76) Inventor: Hirokazu Yoshida, Tokyo (JP)

Correspondence Address: SAMUEL BORODACH, Fish & Richardson P.C., Suite 2800, 45 Rockefeller Plaza, New York, NY, 10111, US

(21) Appl. No.: 10/081,057

(22) Filed: Feb. 21, 2002

(30) Foreign Application Priority Data
Feb. 21, 2001 (JP) P.2001-044660

(51) Int. Cl. H04J 3/24; H04L 12/28

(52) U.S. Cl. 370/474; 370/392

(57) ABSTRACT

A pseudo-random pattern transmission apparatus which has software processing means 1, storage means 2 for storing a pseudo-random pattern, transmission memory 3 for storing a plurality of packets comprising the pseudo-random pattern inserted in sequence into payload parts of a continuous frame of digital signal, an idle sending processing section 4 for calculating the number of inserted idle bytes calculated in response to the specified transmission rate of the digital signal, and transmission control means 6 for alternately executing transmission of a plurality of packets from the transmission memory and transmission of idle bytes from the idle sending processing section to a digital line 7.

### BACKGROUND OF THE INVENTION

1. Field of the Invention

This invention relates to an apparatus for inserting a pseudo-random pattern into payload parts of a PPP frame and an IP packet of PPP over SONET/SDH (POS) in an IP network used in Internet communications and a SONET/SDH network as backbone of the IP network and making the pseudo-random patterns in the payload parts continuous in accordance with the PN pattern generation rule to generate a plurality of PPP frames or IP packets at any desired line utilization ratio

2. Description of the Related Art

In a pseudo-random pattern generation apparatus according to a related art, a pseudo-random pattern is temporarily stored in memory or the like by software and in a packet preparation section, the contents in the memory or the like are reflected on a payload part and a flag and FCS are given and then they are put into a packet and the packet is sent to a line.

At the time, the pattern stored in the memory has a length of one packet and the pattern is stored in the memory by software each time when transmission is conducted.

Thus, transmission traffic can provided on a low-speed interface, but it is difficult to provide transmission traffic on a high-speed interface of a POS or the like; this is a problem.

However, to eliminate a problem of memory write by software, it is also possible to adopt a system for previously storing the circulation portion of the PN pattern of a pseudo-random pattern before transmission is conducted and putting given-length patterns into packets in sequence by a packet processing section for sending.

In such a system, the transmission traffic on a high-speed interface can be provided, but the packet processing section needs to reference the memory contents in sequence and thus address management must be performed, leading to an enormous hardware scale and an increase in costs; this is a problem.

### SUMMARY OF THE INVENTION

It is therefore an object of the invention to provide a pseudo-random pattern generation apparatus that can insert a pseudo-random pattern into a payload part of a PPP frame or an IP packet by software processing for transmission without using a pseudo-random generation circuit of hardware.

To the end, there is provided a pseudo-random pattern transmission apparatus comprising: a pseudo-random pattern storage section (primary memory) 2 adapted to store a pseudo-random pattern; a transmission memory 3 adapted to store a plurality of packets which is constructed by inserting the pseudo-random pattern in sequence into payload parts of a continuous frame of digital signal; a software processing section 1 (CPU software processing section) having an idle sending processing section 1-3 adapted to calculate the number of inserted idle bytes in response to a specified transmission rate of the digital signal; an idle sending section 4 adapted to send an idle byte; a transmission control section 6 (SDH transmission section) adapted to alternately execute transmission of the plurality of packets from the transmission memory and transmission of idle bytes from the idle sending processing section to a digital line 7.

This configuration makes it possible to insert a pseudo-random pattern into a payload part of a PPP frame or an IP packet by software processing for transmission without using a pseudo-random generation circuit of hardware.

The digital signal is an IP packet, so that the pseudo-random pattern can be inserted into the payload part of the IP packet for transmission to the digital line.

The digital signal is a PPP frame, so that the pseudo-random pattern can be inserted into the payload part of the PPP frame for transmission to the digital line.

When the digital signal is a PPP frame, the whole IP packet contained in the PPP frame can be handled as the payload part and the pseudo-random pattern can also be inserted into the IP packet part for transmission to the digital line.

The digital line can also be an SDH line (PPP frame and IP packet of PPP over SONET/SDH (POS) in SONET/SDH network).

As an error can be preset in the pseudo-random pattern, a signal comprising the preset error inserted into a payload part is transmitted, whereby whether or not the error can be detected can be checked at the receiving party.

As the pseudo-random pattern stored in the pseudo-random pattern storage section is data having 2n-1 bits and can be changed arbitrarily, a value, such as 9, 15, or 23, can be used as n.

### BRIEF DESCRIPTION OF THE DRAWINGS

FIG. 1 is a drawing to show the format of a SONET/SDH frame and the relationship between the SONET/SDH frame and a PPP frame.

FIG. 2 is a drawing to show the formats of the PPP frame and an IP packet.

FIG. 3 is a drawing to show a configuration of the invention.

FIG. 4 is a drawing to show a data pattern stored in a transmission memory.

FIG. 5 is a drawing to show a sending timing of data from an SDH transmission section to an SDH line.

### DETAILED DESCRIPTION OF THE PREFERRED EMBODIMENTS

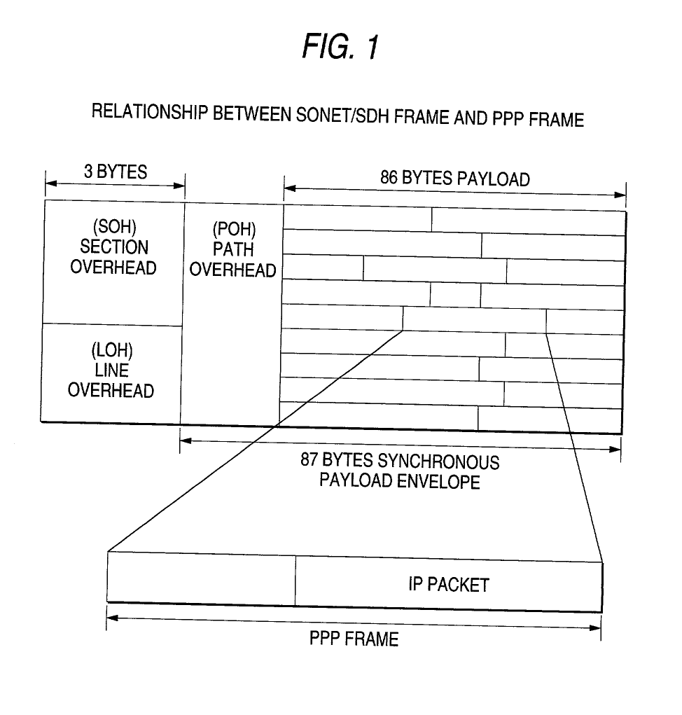

A PPP frame of PPP over SONET/SDH (POS) in a SONET/SDH network used in Internet communications on which the invention is based will be discussed with reference to FIG. 1.

In FIG. 1, a SONET/SDH frame comprises three-byte SOH (Section Overhead) and LOH (Line Overhead), a one-byte POH (Path Overhead), and an 86-byte payload part, which has a plurality of PPP frames each containing an IP packet.

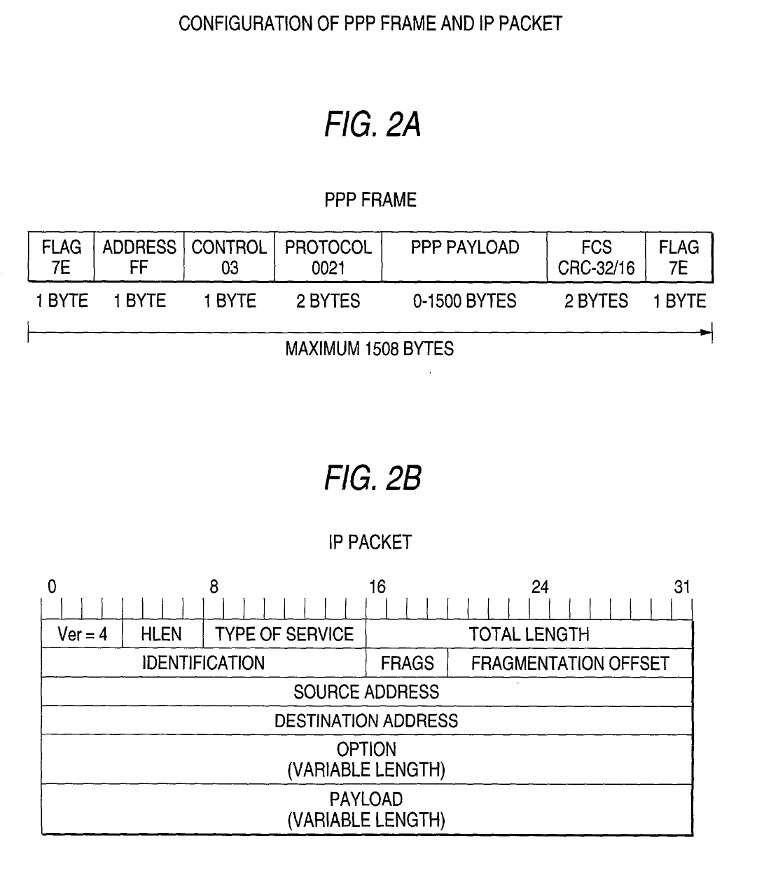

As shown in FIG. 2A, the PPP frame comprises a flag (7E), an address (FF), a control (03), a protocol (0021), a PPP payload, FCS (CRC-32/16), and a flag (7E) and is 1508 bytes at the maximum.

The payload part in the PPP frame is 0 to 1500 bytes.

As shown in FIG. 2B, the IP packet comprises a version number (ver), a header length (in 32-bit units) (HLEN), a service type (Type of Service), a total length (in byte units) (Total Length), a packet identifier (Identification), a fragment control (Frags), an fragment offset (Fragment Offset), a transmission source address (Source Address), a transmission destination address (Destination address), an option (Option), and a payload part (Payload).

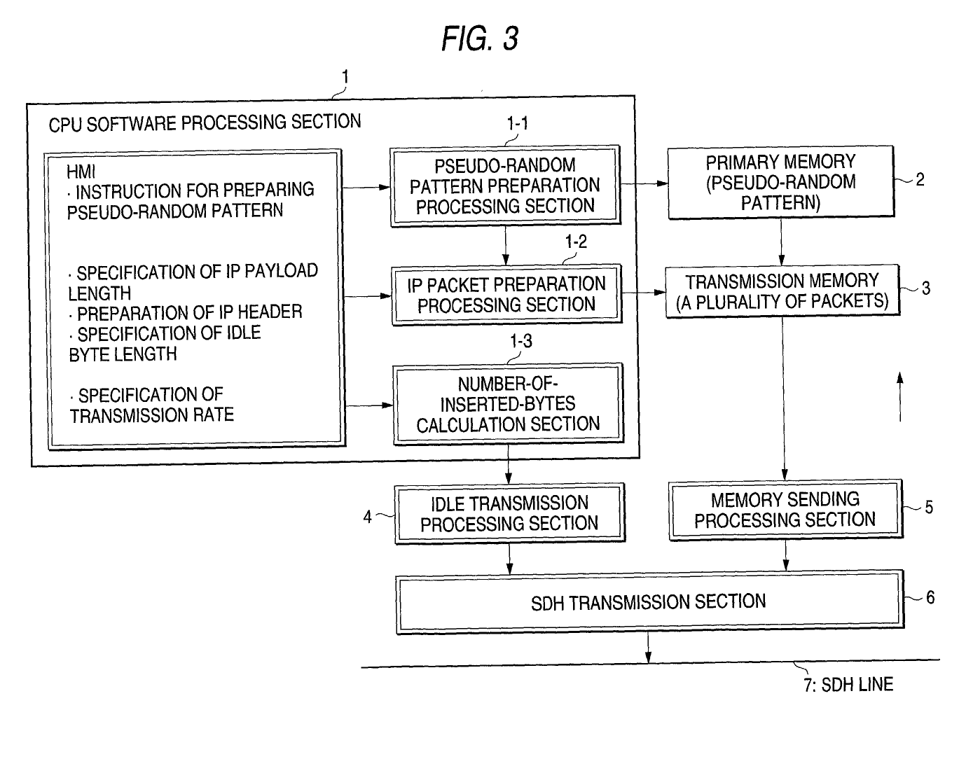

The invention has a configuration shown in FIG. 3.

In FIG. 3, numeral 1 denotes a CPU software processing section, numeral 2 denotes primary memory, numeral 3 denotes transmission memory, numeral 4 denotes an idle transmission processing section, numeral 5 denotes a memory sending processing section, numeral 6 denotes an SDH transmission section, and numeral 7 denotes an SDH line.

The CPU software processing section 1 executes to prepare a pseudo-random pattern by a pseudo-random pattern preparation processing section 1-1 in response to an instruction for preparing the pseudo-random pattern from a human interface (HMI) and stores the prepared pseudo-random pattern in the primary memory 2.

The CPU software processing section 1 executes to prepare an IP packet by an IP packet preparation processing section 1-2 in response to a specification of IP payload length, an instruction for preparing an IP header, and a specification of idle byte length from the human interface (HMI) and stores the prepared IP packet in the transmission memory 3.

The CPU software processing section 1 executes to calculate the number of inserted idle bytes by a number-of-inserted-idle-bytes calculation section 1-3 in response to a specification of transmission rate from the human interface (HMI) and outputs the number of inserted idle bytes to the idle transmission processing section 4.

The pseudo-random pattern stored in the primary memory 2 is sent to the transmission memory 3 and the pseudo-random pattern is inserted into the payload parts of the PPP frame and the IP packet to prepare a plurality of packets and the packets are stored in the transmission memory 3.

The PPP frame and the IP packet with the payload parts into which the pseudo-random pattern is inserted are transmitted through the memory sending processing section 5 from the SDH transmission section 6 to the SDH line 7 together with output of the idle transmission processing section 4.

In packet sending in the invention, data in which a PN pattern is completed is prepared in the primary memory 2 by software processing to prepare the pseudo-random pattern.

The data is repeatedly sent from the memory, whereby the continuity of the PN pattern can be assured.

In the invention, pseudo-random patterns of 32 cycles are used. The reason is obtained from the following conditions:

The pseudo-random pattern consists of 2n-1 bits (n is determined by Recommendation and is 9, 15, 23, etc., for example).

In PPP over SDH, an octet-synchronous data structure is adopted and thus bits of eight cycles are required.

Since the IP packet takes a four-byte boundary structure, bits of four cycles are required.

Next, a packet preparation procedure in the invention will be discussed.

To being with, for the CPU software processing section 1,

template of header part of frame or packet is specified;

payload length of frame or packet is specified; and

the number of idle data bytes (containing the flag sharing byte) between frames or packets is specified from the human interface (HMI) in response to an instruction for preparing pseudo-random pattern.

In response to the specification from the human interface (HMI), the process of inserting the pseudo-random pattern stored in the primary memory 2 into the payload part every given length, performing IP packet header and FCS calculation to prepare a packet, and storing the packet in the transmission memory 3 is repeated.

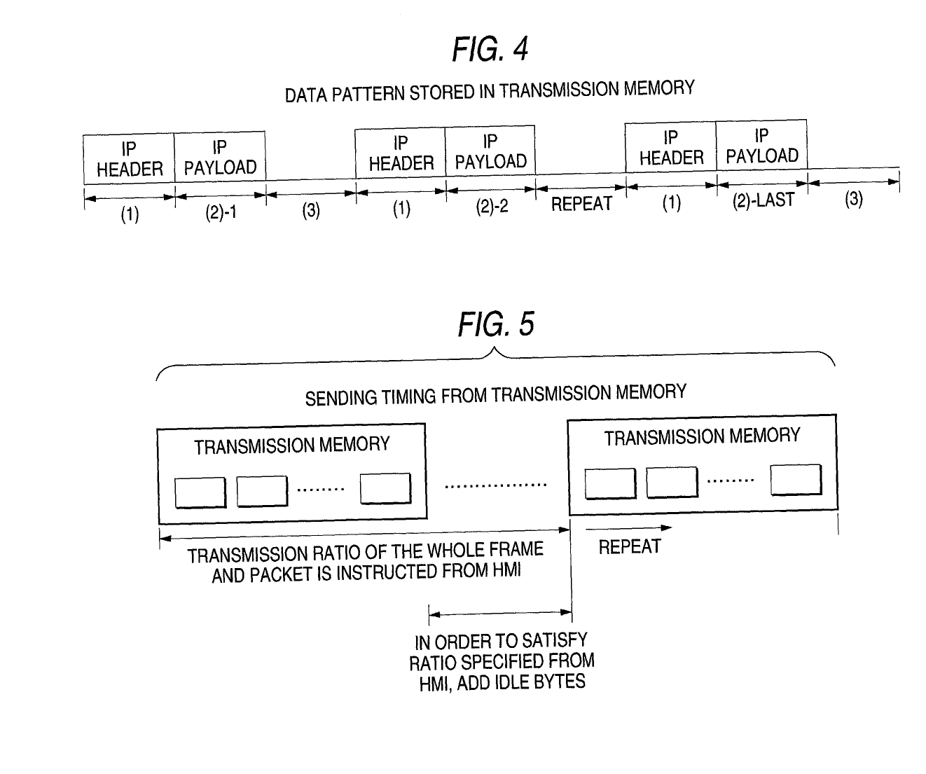

Consequently, the data stored in the transmission memory 3 is prepared as shown in FIG. 4.

FIG. 4 shows the data prepared and stored in the transmission memory 3 in the invention. Basically, the data comprises repetitions of IP header part (1), IP payload part into which pseudo-random pattern is inserted (2), and idle part (3).

Next, a procedure of inserting the pseudo-random pattern into the IP payload part will be discussed.

In FIG. 4, (1) indicates template of header part of frame or packet specified from the human interface (HMI).

In FIG. 4, (2)-1 indicates pseudo-random pattern having the payload length specified from the human interface (HMI) (The pseudo-random pattern is read in sequence by the payload length specified from the human interface (HMI) at a time.) In FIG. 4, (3) indicates as many idle bits as the number of idle data bytes (containing the flag sharing byte) between frames or packets specified from the human interface (HMI).

In FIG. 4, (1) following (3) is the same as the first (1) and indicates template of header part of frame or packet specified from the human interface (HMI).

In FIG. 4, (2)-2 is the same as (2)-1 and indicates pseudo-random pattern of payload length specified from the human interface (HMI) and the pseudo-random pattern is a portion read following (2)-1 from the primary memory 2.

As the process is repeated, (2)-last in FIG. 4 indicates the portion of the remainder of the pseudo-random pattern divided by the payload length specified from the human interface (HMI).

Therefore, (2)-1, (2)-2, . . . (2)-last results in (2)-1+(2)-2+ . . . +(2)-last=32-cycle pseudo-random pattern (bits).

Next, a procedure of the SDH transmission procedure 6 for transmitting the data as shown in FIG. 4, stored in the transmission memory 3 to the SDH line will be discussed with reference to FIG. 5.

To begin with, the sending percentage of the whole frame or packet (the percentage occupied by the whole frame or packet assuming that the total number of bits of SONET/SDH payload is 100%) is specified from the human interface (HMI).

Next, as shown in FIG. 5, the number-of-inserted-idle-bytes calculation section 1-3 calculates how many bytes of idle data are to be sent between transmission memories based on the total number of idle data bytes (containing the flag sharing byte) between the frames or packets stored in the transmission memory 3 and the sending percentage of the whole frame or packet specified from the human interface (HMI), and outputs the number of idle bytes through the idle transmission processing section 4 to the SDH transmission section 6.

Whenever the SDH transmission section 6 transmits data read from the transmission memory 3, it transmits as many idle bytes as the number of idle bytes calculated by the number-of-inserted-idle-bytes calculation section 1-3 to the SDH line 7 consecutively.

As the process is repeated, the packet with the payload containing the pseudo-random pattern is sent to the SDH line 7 at the transmission rate specified on the human interface (HMI).

In the description given above, the pseudo-random pattern is inserted into the payload part in the IP packet; however, it is also possible that the whole IP packet forming a part of the PPP packet is handled as payload into which the pseudo-random pattern is inserted.

To transmit the pseudo-random pattern, it is also possible that a predetermined error is preset in the pseudo-random pattern, whereby whether or not the setup error can be detected at the receiving party is determined.

According to a first aspect of the invention there is provided a pseudo-random pattern transmission apparatus comprising: a pseudo-random pattern storage section 2 (primary memory) adapted to store a pseudo-random pattern; a transmission memory 3 adapted to store a plurality of packets which is constructed by inserting the pseudo-random pattern in sequence into payload parts of a continuous frame of digital signal; a software processing section 1 (CPU software processing section) having an idle sending processing section 1-3 adapted to calculate the number of inserted idle bytes in response to a specified transmission rate of the digital signal; an idle sending section 4 adapted to send an idle byte; a transmission control section 6 (SDH transmission section) adapted to alternately execute transmission of the plurality of packets from the transmission memory and transmission of idle bytes from the idle sending processing section to a digital line 7. Whereby, the pseudo-random pattern can be inserted into the payload part of the PPP frame or the IP packet by software processing for transmission without using a pseudo-random generation circuit of hardware.

According to a second aspect of the invention, the digital signal is an IP packet, so that the pseudo-random pattern can be inserted into the payload part of the IP packet for transmission to the digital line.

According to a third aspect of the invention, the digital signal is a PPP frame, so that the pseudo-random pattern can be inserted into the payload part of the PPP frame for transmission to the digital line.

According to a fourth aspect of the invention, when the digital signal is a PPP frame, the whole IP packet contained in the PPP frame can be handled as the payload part and the pseudo-random pattern can also be inserted into the IP packet part for transmission to the digital line.

According to a fifth aspect of the invention, the digital line can also be an SDH line (PPP frame and IP packet of PPP over SONET/SDH (POS) in SONET/SDH network).

According to a sixth aspect of the invention, as an error can be preset in the pseudo-random pattern, a signal comprising the preset error inserted into a payload part is transmitted, whereby whether or not the error can be detected can be checked at the receiving party.

According to a seventh aspect of the invention, as the pseudo-random pattern stored in the pseudo-random pattern storage means is data made up of 2n-1 bits and can be changed arbitrarily, a value, such as 9, 15, or 23, can be used as n, and the pseudo-random pattern can be processed without adding any hardware.

What is claimed is:

1. A pseudo-random pattern transmission apparatus comprising:
a pseudo-random pattern storage section adapted to store a pseudo-random pattern;
a transmission memory adapted to store a plurality of packets which is constructed by inserting the pseudo-random pattern in sequence into payload parts of a continuous frame of digital signal;
a software processing section having an idle sending processing section adapted to calculate the number of inserted idle bytes in response to a specified transmission rate of the digital signal;
an idle sending section adapted to send an idle byte;
a transmission control section adapted to alternately execute transmission of the plurality of packets from the transmission memory and transmission of idle bytes from the idle sending processing section to a digital line.

2. The pseudo-random pattern transmission apparatus according to claim 1, wherein the digital signal is an IP packet.

3. The pseudo-random pattern transmission apparatus according to claim 1, wherein the digital signal is a PPP frame.

4. The pseudo-random pattern transmission apparatus according to claim 3, wherein whole IP packet forming a part of the PPP frame is handled as the payload part.

5. The pseudo-random pattern transmission apparatus according to claim 1, wherein the digital line is an SDH line.

6. The pseudo-random pattern transmission apparatus according to claim 1 wherein an error is settable in the pseudo-random pattern in advance.

7. The pseudo-random pattern transmission apparatus according to claim 1, wherein the pseudo-random pattern stored in the pseudo-random pattern storage section is data having 2n-1 bits and is changeable arbitrarily.
